(19) United States
(12) Patent Application Publication
(10) Pub. No.: US 2020/0208979 A1
(43) Pub. Date: Jul. 2, 2020

(54) SHIP ROUTING SYSTEM AND METHOD IN SEAS WITH ICE

(71) Applicant: Ashok K. Pandey, Plymouth, MA (US)

(72) Inventor: Ashok K. Pandey, Plymouth, MA (US)

(21) Appl. No.: 16/732,843

(22) Filed: Jan. 2, 2020

Related U.S. Application Data
(60) Provisional application No. 62/787,481, filed on Jan. 2, 2019.

(51) Int. Cl. G01C 21/00; B63B 49/00; G08G 3/00

(52) U.S. Cl. CPC G01C 21/005; G08G 3/00; B63B 49/00

(57) ABSTRACT

A method for navigating a ship through seas with ice includes: determining a route of the ship through a portion of a sea starting from a departure location and ending at an arrival location; rendering a digital ice layer of the portion of the sea using at least one satellite captured image; overlaying the digital ice layer on a geographical map of the portion of the sea, thereby generating an overlaid geographical map; mapping a plurality of waypoints using the overlaid geographical map, wherein the plurality of waypoints navigate around ice of the digital ice layer along the route; transmitting coordinates of the plurality of waypoints to the ship; and piloting the ship along the route from the departure location to each of the plurality of waypoints and to the arrival location.

### CROSS-REFERENCE TO RELATED APPLICATION

This application claims the benefit of priority of U.S. provisional application No. 62/787,481, filed Jan. 2, 2019, the contents of which are herein incorporated by reference.

### BACKGROUND OF THE INVENTION

The present invention relates to ship navigation and, more particularly, to a ship routing system and method in seas with ice.

Presence of sea ice in the Arctic region presents a danger to surface navigation for ships in a remote region that lacks infrastructure and communication capabilities. Receding sea ice in the Arctic region has resulted in an exponential rise in ship traffic in recent years and the trend is expected to grow in future.

The trans-Arctic routes substantially reduce intercontinental distances between North East Asia and North America/North West European ports compared to sub-Arctic routes, hence commercially attractive. The intra-Arctic and inter-Arctic trade is expected to rise as LNG and bulk minerals trade picks up steam. Leisure and cruise shipping are also increasing in frequency. Broken and smaller ice fragments caused by the sea ice melt results in a heightened risk of ship-ice interaction, which increases the chances of ship damage and potential oil pollution caused by breach in the ship's hull and damage to oil storage tanks onboard.

As can be seen, there is a need for a risk mitigation and management system in the Arctic sea region that makes shipping safer and protects the fragile eco-system.

### SUMMARY OF THE INVENTION

In one aspect of the present invention, a method for navigating a ship through seas with ice, the method comprises: determining a route of the ship through a portion of a sea starting from a departure location and ending at an arrival location; rendering, via software running on the computer, a digital ice layer of the portion of the sea using at least one satellite captured image; overlaying, via software running on the computer, the digital ice layer on a geographical map of the portion of the sea, thereby generating an overlaid geographical map; mapping, via software running on the computer, a plurality of waypoints using the overlaid geographical map, wherein the plurality of waypoints navigate around ice of the digital ice layer along the route; transmitting coordinates of the plurality of waypoints to the ship; and piloting the ship along the route from the departure location to each of the plurality of waypoints and to the arrival location.

These and other features, aspects and advantages of the present invention will become better understood with reference to the following drawings, description and claims.

### BRIEF DESCRIPTION OF THE DRAWINGS

FIG. 1 is a flow chart of an embodiment of the present invention;

FIG. 2 is a flow chart of an embodiment of the present invention; and

FIG. 3 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The ability to chart an optimized route in an ice field for voyage planning purposes poses a major challenge in decision making with respect to a) the speed of advance and b) a tactical route depending on ship characteristics and ice resistance. The present invention presented here solves this problem while staying within the stipulations and guidelines of the ongoing IMO e-navigation Strategic Implementation Plan. The two fundamental tenets of route optimization that the tool utilizes in this process are, a) route safety and b) route economy.

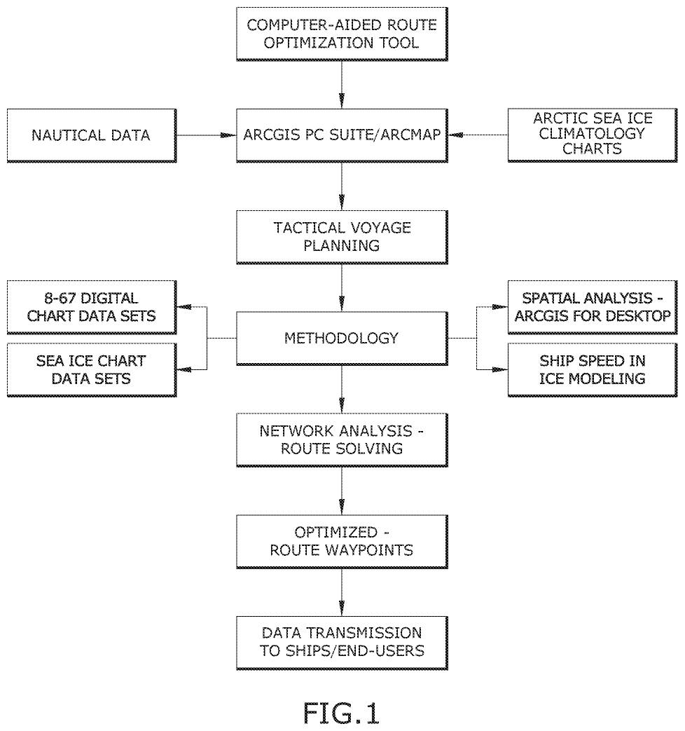

The present invention, which may be called the Computer-aided Route Optimization Tool (CaROT), is a decision-making system that uses actual ice conditions (as derived by satellite or visual observations), ship's ice class and ship's characteristics (engine capacity, draft and disposition) to calculate waypoints based on the degree of impedance (resistance) in an ice field. Voyage planning can be performed in advance of entering an ice field by integrating digital sea-ice data of the Arctic region, for instance with the Electronic Navigation Charts (ENC), of the area in Geographic Information System (ArcGIS). Sea-ice is the largest impedance factor affecting ship speed and thus the ‘CaROT’ has used ice data to build the model by creating map layers in ArcGIS. FIG. 1 illustrates a flowchart of the above-mentioned model.

Advancement in digital technology, ship-shore data exchange and PC-based solutions of the present invention provides shipping route coordinates to mariners onboard very efficiently. This enhances the decision-making capability of the mariner in plotting safer routes while sailing in an ice regime/ice infested water. The CaROT is data driven and can calculate optimized and alternate routes based upon the sea-ice data input as received from satellite imagery. These features allow current input of sea-ice data in the system to get an accurate output in terms of speed of advance as well as the trajectory while the vessel navigates the ice regime. These features also allow for a manual input of sea ice data (as observed from the ship's bridge) by the mariner in case visual observations differ from satellite derived sea-ice predictions.

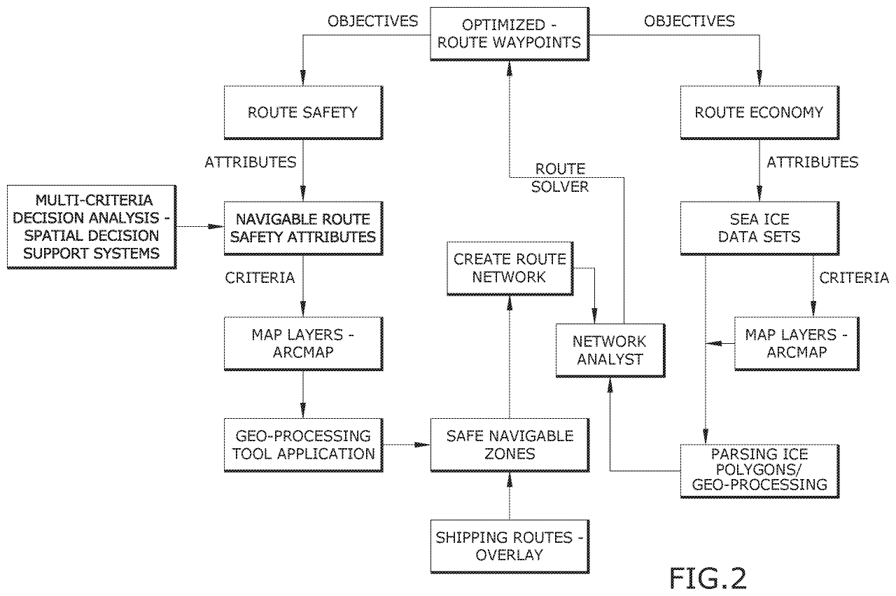

The sequential steps used to build the optimized route waypoints is generated using software running on a computer, such as a standalone PC/mobile device, and is illustrated in FIG. 2. First a route of the ship through a portion of a sea is determined starting from a departure location and ending at an arrival location. The route is determined using the following criteria: route safety objective; navigable route attributes; Arctic Map (ArcMap) layers of a two or three-dimensional geographical information system; geo-processing tool application of the ArcGIS; shipping routes overlay; creation of Safe Navigable zone; multi criteria decision analysis; and creating the digital route network in ArcGIS. Then additional waypoints are determined that navigate the ship around sea ice. The additional waypoints are determined using the following: route economy objectives; sea ice data set collation (satellite captured images); sea ice-Arctic Map layers (rendering digital ice layers of the portion of the sea using at least one satellite captured image); parsing ice polygons and geoprocessing of the ArcGIS (overlaying the digital ice layers on a geographical map of the portion of the sea, thereby generating an overlaid geographical map); data Modelling-Network Analyst (mapping plurality of waypoints using the overlaid geographical map); and finding the optimized route between two points (the plurality of waypoints navigate around ice of the digital ice layer along the route from the departure location to the arrival location).

Acquisition of relevant data from Electronic Navigational charts and use of geoprocessing in ArcMap desktop produces a safe navigable zone for the ship in question. Optimized routes are calculated by the ‘Route solver’ that is eventually converted into geographical coordinates as the final output. The CaROT output can be directly used by the mariner to plot waypoints on navigation charts, adjust ship's speed and plot courses to navigate with optimal resistance (due sea-ice) and definitive voyage estimates. It not only contributes to safer and economical passage in ice but also predicts the time of transit in an ice field. The number of impediments besides ice could include climatological data such as wave and swell height, wind direction that improves the model even further. There are many other factors such as ice pressure that could be also be included for computation of the least cost path and the optimized route

The final output from the process are the geographical coordinates generated between two fixed points at sea along with the safe speed of approach while the ship is underway. Acquisition of satellite derived sea-ice data is a prerequisite that can be computed ashore and hosted on a webpage with access to ships via satellite link. The geographical coordinates (Latitude and Longitude) can be easily plotted on the chart and ship speed adjusted to reduce contact damage (increased safety) as available from the CaROT.

The present invention provides the following to a mariner that is not readily available while navigating in sea-ice: a) a safe speed of advance in sea-ice, b) voyage planning on the go; routes may keep changing with varying sea-ice regime, c) manual over-ride of sea ice characteristics, if predicted data is in variance with visual ‘bridge’ observations, and d) a transit time can be calculated for the ice leg part of the voyage. Each of the four items are important to commercial navigation where a shipping line must be able to do ship scheduling and deliver cargo within a specific time frame for its customers. The container shipping industry for instance would prefer port rotation and ship scheduling months in advance due to its nature of business to enable freight forwarders plan their own container management logistics, a critical element in the global supply chain.

As mentioned above, the present invention is used to generate a plurality of waypoints to navigate around ice of a sea along a route. A “waypoint” is a position chosen as a destination for navigation as part of the route. The route has one or more waypoints. That is, a route is composed of waypoints, including at least one final waypoint, and one or more intermediate waypoints.

The ship of the present invention may be any type of boat that navigates on the sea. The ship may include an onboard computer, a global positioning system, and a communications adapter implementing data communications connections to other computers, which may be wireless networks, satellites, servers, or others as will occur to those of skill in the art. Communications adapters implement the hardware level of data communications connections through which the ship transmits and receives wireless data communications.

The present invention includes transmitting the coordinates of the waypoint from a computer to the ship. Transmitting the coordinates of the waypoint to the ship may be carried out by use of any data communications protocol, including, for example, transmitting the coordinates as form data, URI encoded data, in an HTTP message, a WAP message, an HDML message, or any other data communications protocol message as will occur to those of skill in the art.

Such exemplary methods of navigating a ship also include storing the coordinates of the waypoints in computer memory on the ship, piloting the ship to each waypoint in accordance with one or more navigation algorithms, and operating the ship at each waypoint in accordance with the ship instructions for each waypoint. Ship instructions to perform tasks in connection with a waypoint may be encoded in, for example, XML (the extensible Markup Language).

As mentioned above, the ship is piloted along the route from the departure location to each of the plurality of waypoints and to the arrival location. An exemplary method of piloting the ship may be in accordance with a navigation algorithm. The navigation algorithm includes periodically repeating the steps of:
reading from the GPS receiver a current position of the ship;
calculating a heading from the current position to the waypoint;
turning the ship to the heading; and
driving the ship on the heading.

In this method, if Lon₁, Lat₁ is taken as the current position, and Lone, Late is taken as the waypoint position, then the heading may be calculated generally as the inverse tangent of ((Lat₂−Lat₁)/(Lon₂−Lon₁)).

The ship may be periodically updated with adjusted waypoints while piloting the route. For example, a computer may periodically receive new satellite images of the portion of the sea; determine discrepancies between the at least one satellite image and the new satellite images; adjust the plurality of waypoints based on the new satellite images if discrepancies are determined; and transmit coordinates of the adjusted plurality of waypoints to the ship. The ship may then be piloted in accordance with the adjusted waypoints.

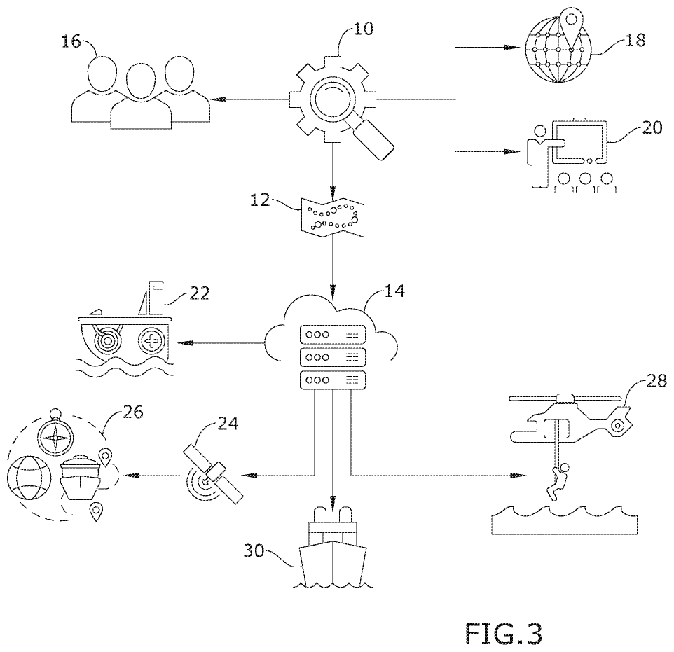

As illustrated in FIG. 3, the optimized waypoint route 12 may be generated by software running on a computer 10, utilizing navigational data 18 and data inputs from multiple users 16. The optimized waypoint route 12 may be used for simulation and training 20. Additionally, the optimized waypoint route 12 may be stored on a memory of a web server 14 or other computing system that is capable of wirelessly transmitting the optimized waypoint route 12. The optimized waypoint route 12 may be transmitted to ice-breaking ships 30, to a voyage planning ship 26 via satellite transmission 24 or other wireless transmission means, and additionally may be sent to emergency response ships 22 as well as search and rescue helicopters 28.

It should be understood, of course, that the foregoing relates to exemplary embodiments of the invention and that modifications may be made without departing from the spirit and scope of the invention as set forth in the following claims.

What is claimed is:

1. A method for navigating a ship through seas with ice, the method comprising:
determining a route of the ship through a portion of a sea starting from a departure location and ending at an arrival location;
rendering, via software running on the computer, a digital ice layer of the portion of the sea using at least one satellite captured image;
overlaying, via software running on the computer, the digital ice layer on a geographical map of the portion of the sea, thereby generating an overlaid geographical map;
mapping, via software running on the computer, a plurality of waypoints using the overlaid geographical map, wherein the plurality of waypoints navigate around ice of the digital ice layer along the route;
transmitting coordinates of the plurality of waypoints to the ship; and
piloting the ship along the route from the departure location to each of the plurality of waypoints and to the arrival location.

2. The method of claim 1, generating, via software running on a computer, a geographic information system of the portion of the sea encompassing the route of the ship, wherein the geographic information system is the geographical map.

3. The method of claim 2, wherein the rendering of the digital ice layer is a rendering overlaid on the geographic information system.

4. The method of claim 3, wherein the plurality of waypoints are mapped using the overlaid geographic information system.

5. The method of claim 1, further comprising steps of:
determining, using software running on the computer, speed adjustments at a plurality of locations along the route;
transmitting the speed adjustments to the ship; and
adjusting a speed of the ship based on the speed adjustments at the plurality of locations while piloting the ship along the route.

6. The method of claim 5, wherein the speed adjustments are based on a size of the ship and a location of the waypoints.

7. The method of claim 1, further comprising steps of:
periodically receiving new satellite images of the portion of the sea;
determining, via software running on the computer, discrepancies between the at least one satellite image and the new satellite images;
adjusting, via software running on the computer, the plurality of waypoints based on the new satellite images if discrepancies are determined; and
transmitting coordinates of the adjusted plurality of waypoints to the ship.
